(19) United States
(12) Patent Application Publication
(10) Pub. No.: US 2016/0327229 A1
(43) Pub. Date: Nov. 10, 2016

(54) ILLUMINATION OF DENSE URBAN AREAS BY LIGHT REDIRECTING SINE WAVE PANELS

(71) Applicant: SCIENCE AND TECHNOLOGY DEVELOPMENT FUND (STDF), Cairo (EG)

(72) Inventors: Amr Mohamed Ezzat SAFWAT, Cairo (EG); Khaled Mohamed NASSAR, Cairo (EG); Ola Mohamed Galal El-Din Ali FAHMY, Cairo (EG); Sally Ibrahim Mahmoud Mohamed Farag EL-HENAWY, Cairo (EG); Mohamed Wagih Nairn MOHAMED, Cairo (EG); Islam Ayman Kamal Mohamed Abdellatif MASHALY, Cairo (EG); Osama Nabil MOHAMED, Cairo (EG)

(21) Appl. No.: 15/109,691

(22) PCT Filed: Jan. 1, 2015
(86) PCT No.: PCT/EG2015/000001

§ 371 Date: Jul. 5, 2016

(30) Foreign Application Priority Data
Jan. 9, 2014 (EG) 2014010032

(51) Int. Cl. F21S 11/00; G02B 3/04; F21V 14/06; G02B 19/00

(52) U.S. Cl. CPC F21S 11/002; G02B 19/0042; G02B 19/0014; G02B 3/04; F21V 14/06

(57) ABSTRACT

The presented system is a cost effective and energy saving mean of transmitting sunlight downward into a narrow alleys and streets, by using a day-lighting guiding acrylic panel that is capable of changing the direction and distribution of the incident light. The core of the proposed daylight guidance system is made up of light transmission panels that have sine wave shaped cross-section so that the panel functions as an optical diffusor perpendicular to the optical axis. The system consists of the panels and a lattice frame, which supports the panel. The proposed system is to be mounted on the building roof facing the sun but, since building sizes and orientations are different the frame is designed to be easily rotated to adopt different solar conditions such that substantially deep light penetration and high luminance level can be achieved.

### TECHNICAL FIELD

This invention relates to the field of non-imaging Optics for Illumination in general and more specifically to a system that transmits sunlight downward into narrow alleys and streets deprived from sun light using a day-lighting guiding acrylic corrugated panel.

### BACKGROUND ART

Cities and towns around the world are becoming more condensed due to the shrinking amount of buildable areas in city centers and suburbs and consequently; high density urban development is becoming the norm. This significantly reduces the amount of sunlight that occupants have access to, encroaches on their fundamental right to light and causes psychological and physiological health problems. Moreover; lack of natural daylight leads to an increase in energy use since the reliance on artificial lighting increases. Even natural circumstances may cause deprivation for sunlight, where cities are situated in deep valleys such that mountains block the sun rays.

Several systems were developed to redirect sunlight using either redirecting panels, mirrors or guiding tubes. Some of the systems when operating depend on light reflection as the case in LUMITOP®, mirrors and light shelves, other systems depend on light refraction such as micro-prismatic panels.

Unfortunately; the available sunlight guiding systems, except for the mirrors, in spite of being cost effective and simple, redirect sunlight beam upwards into room ceilings. Also, they are optimized for certain solar altitude range adopting specific conditions. So, these systems can neither increase daylight in dense urban areas nor provide daylight to valleys blocked by mountains. Even for the mirrors which are used to redirect light downwards, they are automatically controlled to capture daylight, such systems are not recommended because of high energy losses in the driving systems and high cost.

### BRIEF DESCRIPTION OF DRAWING

FIG. 1 is the perspective view of the sinusoidal sunlight guiding panel.

FIG. 2 is the cross sectional view of the proposed sinusoidal structured panel.

FIG. 3 is a schematic view of the sunlight path when it hits the sinusoidal structured panel.

FIG. 4 is a representative schematic of the interface angle θᵢ the angle between the incident ray 6 and the interface normal 10, and the output exit angle θₒ, the angle between the reference plane 7 and the exit ray 8.

FIG. 5 is a schematic that shows how the interface angle θᵢ and the exit angle θₒᵤₜ vary with the sinusoidal structured surface profile.

FIG. 6 is a representation of the parametric variation of the sine wave amplitude variation A.

FIG. 7 is a representation of the parametric variation of the sine wave period variation λ.

FIG. 8 shows the relation between beam incident angle θᵢₙ, the minimum outgoing angle θₘᵢₙ, the maximum outgoing angle θₘₐₓ and fan out angle θ_{f}.

FIG. 9 is a representation of the variation of both minimum outgoing angle θₘᵢₙ and maximum outgoing angle θₘₐₓ as well as the fan out angle θ_{f} with respect to different incident angles θᵢₙ₁ and θᵢₙ₂.

FIG. 10 is a perspective view of the sunlight guiding system of the present invention. The guiding system consists of sinusoidal structured plates 1, lattice frame 4 and the fixation structure 15.

FIG. 11 is an illustration of the minimum angle of θₘₐₓθ_{Lmax} and the maximum angle of θᵢₙθ_{Lmin}.

### SUMMARY OF THE INVENTION

The best mode for the panel to redirect sunlight efficiently for the longest period is to be placed on roof tops such that it faces the sun at noon.

The proposed system is to be mounted on the building roof facing the sun so as to redirecting incident sunlight downward into the narrow alleyways and streets. Since building sizes and orientations are different the frame is arranged, by adjusting the tilt angle θₜᵢₗₜ, such that substantially deep light penetration and high luminance level can be achieved. No need for further adjustment, since the design is optimized to cover different seasons of the year.

### DISCLOSURE OF THE INVENTION

To overcome the shortcomings of the prior art and to increase daylight in dense urban areas and to provide daylight to valleys blocked by mountains without energy loss, the present invention introduces a new technique of transmitting sunlight downward into narrow alleys and streets using a day-lighting guiding acrylic corrugated panel.

The present invention makes use of the optical characteristics of line generator lens [Powell lens] that is able to transform a point wise light beam into a straight line with uniform distribution by dealing with plane wave (the sunlight).

The panel orientation is optimized with respect to the sun in order to make use of the redirected sun for the longest period possible.

The panels have high quality corrugations of sine wave shaped cross-section such that the panel functions as an optical diffuser perpendicular to the sunlight.

This sine wave shaped corrugated panels diverge the incident sun light, which is a plane wave, with different angles corresponding to different points of incidence across the sine period. This provides a fan out angle that differs slightly as the angle of incidence (i.e.: the Solar Altitude angle SA) changes, so the sun light is redirected and spread to illuminate those deep dark places.

As the tilt angle of the panel with respect to the building changes the incident angle of sun light changes, consequently the angle by which the redirected rays emerge changes leading to a better coverage for certain solar altitude range.

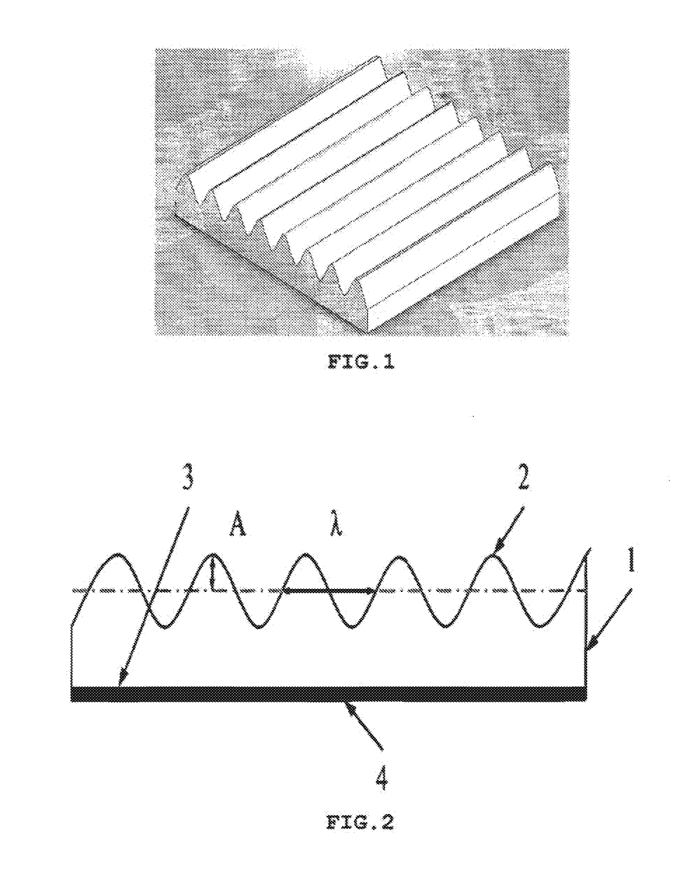

Referring to FIG. 1, the system is based on a panel with sine wave shaped cross section with a perspective view of sunlight guiding panel. The panel is provided with linear array of sinusoidal structure. The structure is formed on the first surface of the panel while the second surface of the panel is substantially smooth surface.

Referring to FIG. 2, the cross section of the panel 1, the entrance boundary surface has a sine wave shaped corrugations 2, where the exit surface is a smooth surface 3. While, λ represents the sinusoidal structure period and A its amplitude.

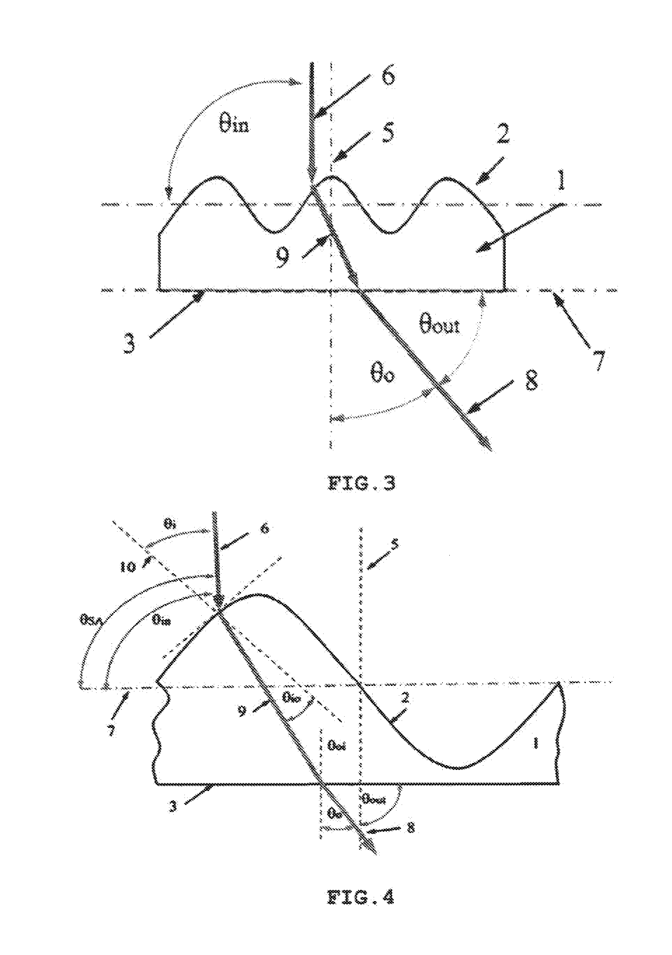

Referring to FIG. 3, the incoming sunlight is incident with an angle θᵢₙ and the outgoing light 8 is refracted at angle θₒ (i.e.: exit with output angle θₒᵤₜ). Where, incident angle θᵢₙ is defined as the angle between the incident rays 6 and the reference plane 7, the flat surface of the panel, the output angle θₒᵤₜ is defined as the angle between the reference plane 7 and the output beam 8, and the refraction angle θₒ is the angle between the reference panel's normal 5 and the output beam 8.

The underlying idea for spreading the light is that the sine wave has a varying slope (plane of incidence of the sunlight rays) across its period, so the refracted rays diverge within the sine period emerging with different angles.

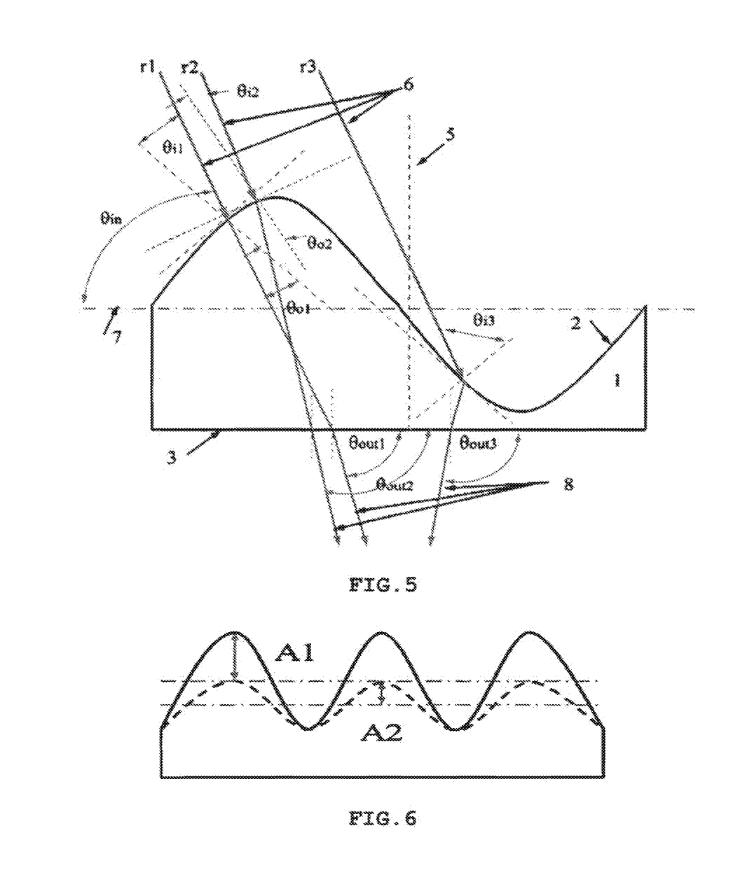

Referring to FIG. 4 and FIG. 5, the interface angle θᵢ of the incoming light changes as the incoming light hits different points on the sine wave surface. The refraction angle θₒ varies monotonically with the incoming light on the entrance surface 2. Where θᵢ is the angle of interface, measured relative to the first boundary surface normal 10, sinusoidal structured surface normal, and θₒ is the angle of refraction at the second boundary surface, smooth surface 3.

The impact of the sunlight guiding panel design parameters, sine amplitude and period, and panel's refractive index on its performance is studied. The studies conclude that the performance is greatly affected by the sine wave amplitude to its period ratio as follows. The maximum and minimum outgoing angle varies with varying the sine amplitude and period which in turn affects the fan out angle. Studying the effect of the amplitude and period variation on the outgoing angles shows that; for the same amplitude the fan-out angle increases as the period decreases, for the same period the fan-out angle increases as the amplitude increases and finally for the same period and amplitude of sine wave, the fan out angle increases as the refractive index of the material increases.

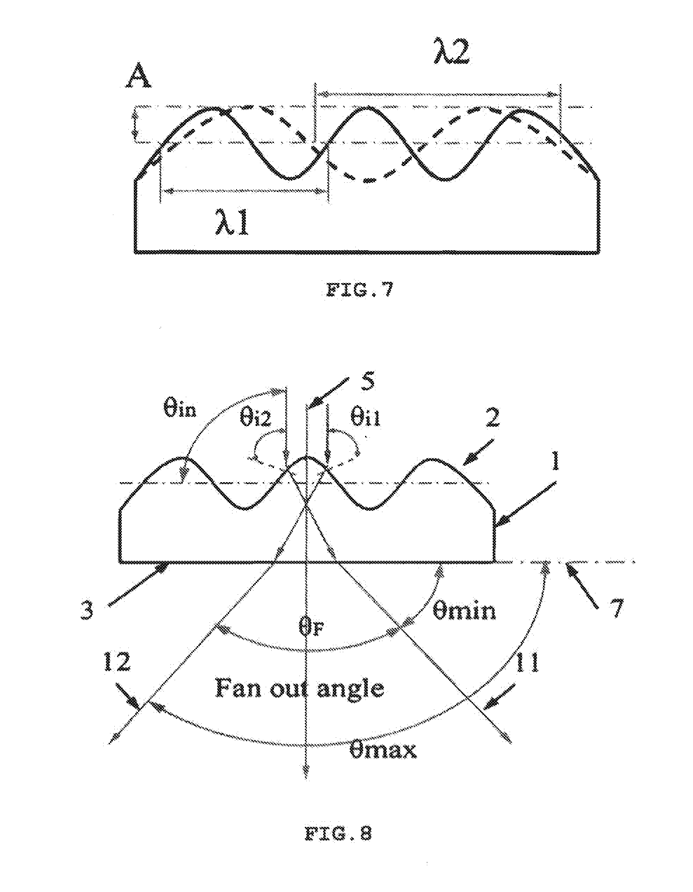

FIG. 6 represents amplitude variation of the sinusoidal structured surface with constant period, and FIG. 7 represents period variation of the sinusoidal structured surface with constant amplitude.

FIG. 8 illustrates the relation between the incident angle θᵢₙ, the minimum outgoing angle θₘᵢₙ, the maximum outgoing angle θₘₐₓ and the fan out angle θ_{F}.

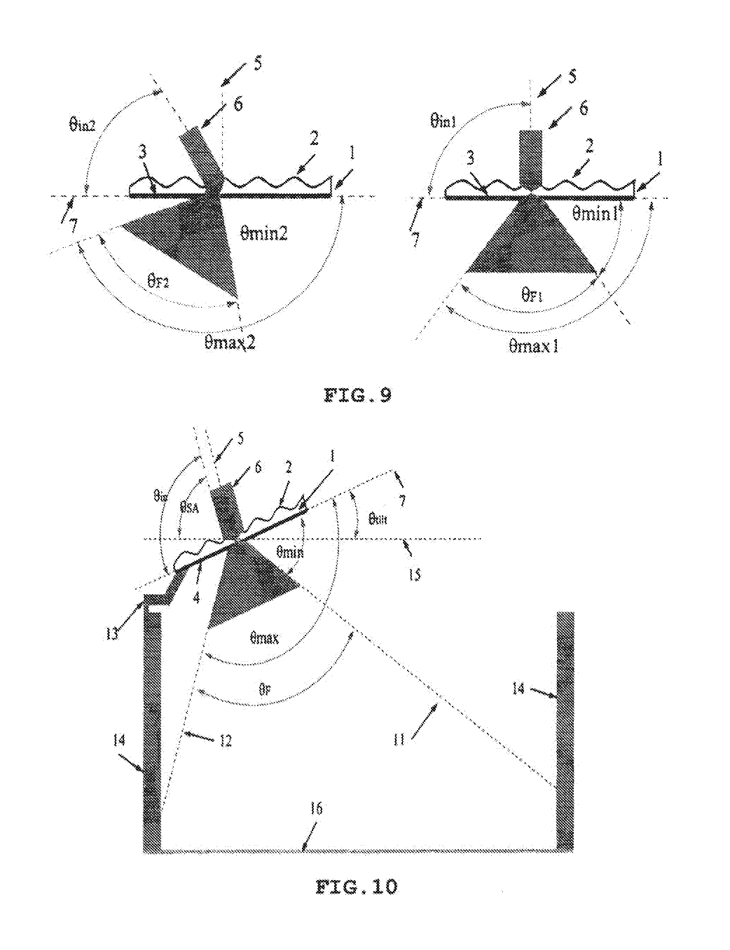

FIG. 9 represents the variation of the minimum outgoing angle θₘᵢₙ, the maximum outgoing angle θₘₐₓ as well as the fan out angle θ_{F} with respect to incident angle θᵢₙ.

Consequently; minimum outgoing angle θₘᵢₙ, maximum outgoing angle θₘₐₓ and fan out angle θ_{F} are function of the incident angle of sunlight beam as well as the design parameters of the panel; such as sine wave amplitude A, period λ, and the refractive index of the material.

FIG. 10 shows the sunlight guiding system construction of the present invention. The guiding system consists of sinusoidal structured plate 1, the lattice frame 4 and fixating structures 13. The lattice frame is supported such that it can be tilted in both directions, upwards and downwards, with angle Stilt to cover different solar altitude range and adopt various solar conditions.

From FIG. 10, the incident angle θᵢₙ is the angle between the incident ray and the reference plane 7. Where, reference plane 7 is the plane parallel to second smooth surface 3, of sunlight guiding panel.

The minimum outgoing angle θᵢₙ is the angle between the reference plane 7 and the right outgoing ray where the exit light intensity is very low 11. And, the maximum outgoing angle θₘₐₓ is the angle between the reference plane 7 and the left outgoing ray where the exit light intensity is very low 12.

Further, the difference between θₘₐₓ and θᵢₙ is defined as the fan out angle θ_{F}, θₜᵢₗₜ is the angle between the reference plane 7 and horizontal plane 15. Where, the solar altitude θ_{SA} is the angle between the incident ray line 6 and the horizontal plane 15.

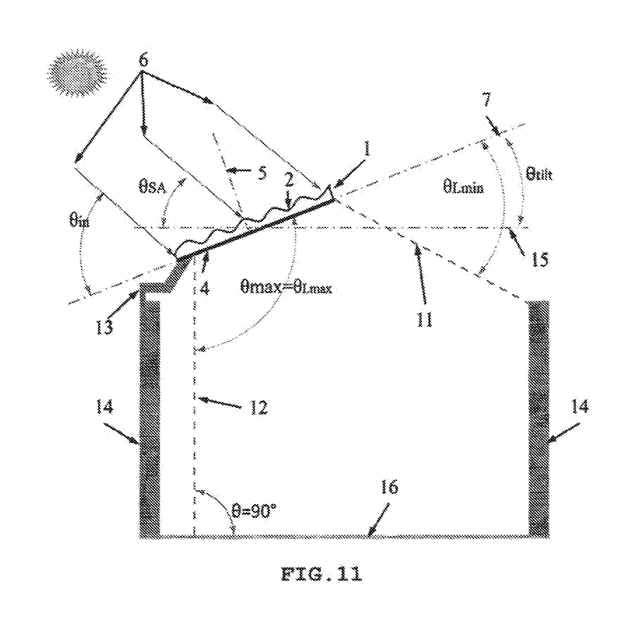

The analysis and optimization of the panel's parameters are performed to make sure that for different incident angle the redirected outgoing angle reaches the far left end of the well or the narrow Street and stay within the targeted area. The analysis results show that the maximum outgoing angle should be greater than 90°+θₜᵢₗₜ and the minimum outgoing angle should be greater than Nₜᵢₗₜ. FIG. 11 shows the minimum angle of θₘₐₓ which is θ_{Lmax}, and the minimum angle of θₘᵢₙ which is θ_{Lmin}.

θᵢₙ: Incident angle which is the angle between the incident ray 6 and the reference plane.

θₒᵤₜ: Outgoing angle, exit angle which is the angle between the exit ray and the reference plane.

θᵢ: Interface angle which is the angle between the incident beam and interface surface normal.

θᵢₒ: The angle of refraction at the first boundary surface and the sine wave interface normal.

θₒ: The angle of refraction at the second boundary surface, smooth surface 3.

θₘᵢₙ: Minimum Outgoing angle or minimum exit angle which is the angle between the reference plane and the right outgoing beam where the light intensity is very low.

θₘₐₓ: Maximum Outgoing angle or maximum exit angle which is the angle between the reference plane and the left outgoing beam where the light intensity is very low.

θ_{f}: Fan out angle which is the difference between the maximum outgoing angle and minimum outgoing angle.

θ_{SA}: Solar altitude which is the angle between the sunlight incident ray and the horizontal plane.

θₜᵢₗₜ: Tilting angle which is the angle between the reference plane and the horizontal plane.

θ_{Lmin}: Minimum Outgoing limiting angle or minimum exit limiting angle.

θ_{Lmax}: Maximum Outgoing limiting angle or maximum exit limiting angle.

1. A system for redirecting light downwards to illuminate areas deprived from natural lighting covering a wide range of solar altitudes, comprising:
a panel for diverging the light; a supporting system that holds an array of panels.

2. The light redirecting system in claim 1, wherein the panel have sine wave shaped corrugations on one side and flat surface on the other side for diverging light uniformly upon falling on its surface providing uniform lighting that is spread with a certain fan out angle.

3. The panel in claim 2, wherein the panel comprising: the sine wave amplitude; the sine wave period.

4. The sine wave period in claim 3, wherein as the sine wave period increases the maximum and minimum divergence angels decrease and vice versa, so changing it varies the fan out angle.

5. The sine wave amplitude in claim 3, wherein as the sine wave amplitude increases the maximum and minimum divergence angels increase and vice versa, so changing it varies kthe fan out angle.

6. The light redirecting system in claim 1, wherein the supporting system comprising: a frame; fixation rods; rotation pivot.

7. The supporting system in claim 6, wherein the panels are stacked in the frame with their corrugated side upwards facing the sun.

8. The supporting system in claim 6, wherein the rotation pivot helps the frame to be tilted in both directions, upwards and downwards, so it offers a wide range of angles.
